(19) United States
(12) Patent Application Publication
(10) Pub. No.: US 2004/0120543 A1
(43) Pub. Date: Jun. 24, 2004

(54) Structure improvement for speaker unit

(75) Inventor: Szu-Wei Sun, Taoyuan Hsien (TW)

Correspondence Address: TROXELL LAW OFFICE PLLC, SUITE 1404, 5205 LEESBURG PIKE, FALLS CHURCH, VA, 22041, US

(73) Assignee: Galax Multimedia Co., Ltd.

(21) Appl. No.: 10/326,136

(22) Filed: Dec. 23, 2002

(51) Int. Cl. H04R 1/00; H04R 9/06; H04R 11/02

(52) U.S. Cl. 381/424; 381/404

(57) ABSTRACT

The present invention Structure Improvement for Speaker Unit is disclosed. The speaker unit includes voice coil and housing of yoke as the main body, and above the circular slot hole that is used to accommodate the voice coil and yoke is bond with a surround and a diaphragm, the inner and outer fringes of its surround respectively formed the first skirt and the second skirt, so its surround incorporates the first skirt and the fringe of circular slot hole in the way of lap joint, and the inner fringe of the second skirt is provided for the joint of the diaphragm; the key point is: the out fringe of the diaphragm fitted to form a third skirt, thereby the diaphragm combines the surround as a configuration due to the binding between the third lap and the second skirt in the way of lap joint, besides a definite region for coating, support and fix emerged by setting the outer fringe of the diaphragm, so as to facilitate the operation for coherence between the membrane and the surround.

### BACKGROUND OF THE INVENTION

1. Field of the Invention

The present invention Structure Improvement for Speaker Unit is intended for providing a speaker unit structure facilitating the coherency of the diaphragm and surround, as well as support and fix, mainly producing a third skirt on the outer fringe of the diaphragm, an integral configuration of the diaphragm with the surround hereby formed by combining the third skirt with the second skirt in the way of lap joint, in addition a definite region for coating, supporting and fix emerged by the setting of the third skirt outer of diaphragm outer fringe; particularly, the second skirt of surround's inner fringe and the third skirt of the diaphragm's outer fringe are set from internal to outside, slantwise spreading-out, therefore the vibration of the diaphragm and surround will not be impacted by the lap joint between the second skirt and the third skirt.

2. Description of the Prior Art

Referring to FIG. 1, it is a structure exploded view of the conventional speaker unit, wherein the speaker unit includes a housing (A) accommodating voice coil (B) and yoke (C) as the main body, above the circular slot hole (Al) of the housing (A) binding a surround (D) and a diaphragm (E), however the function of its surround (D) is of constituting the suspension link between diaphragm (E) and housing (A), hereby the diaphragm (E) vibrates following the action of the voice coil (B) and yoke section (C), consequently produces sound wave effect.

In addition, its diaphragm (E) ceaselessly vibrates following the voice coil (B) and yoke section (C) during the action of the speaker unit, and so it is necessary that the unit adheres to the housing (A) stably for regular service, on this account the speaker unit respectively forms the first skirt and second skirt on the outer and inner fringes of the surround, meanwhile a step section is formed among the body of the circular slot hole's fringe housing, thereby the surround is possible lap connection between the first skirt and the step section on the fringe of circular slot hole, and the second skit of inner fringe is proved for the joint of diaphragm.

The diaphragm and surround are made from different materials, they must be combined in the way of coherency, but some small sizes speak unit are too difficult coat to cohere when cohering the diaphragm and the surround, even the coherency effect is so limited, so that the volume range performance will be directly impacted if the diaphragm and surround are not bond completely.

### SUMMARY OF THE INVENTION

The main purpose of the present invention Structure Improvement for Speaker Unit is to form a third skirt based on the coordination of the diaphragm's outer fringe, hereby the integral configuration of the diaphragm and the surround is formed by lap joint cohering between the third and second skirts, in addition a definite region for coating, support and fix emerged by the setting of the third skirt of diaphragm fringe, therefore convenient for the coherency between the diaphragm and the surround..

The other object of the present invention Structure Improvement for Speaker Unit is of configuring the second skirt of surround's inner fringe and the third skirt of diaphragm's outer fringe from internal to external, slantwise spreading-out, then the vibration of the diaphragm and surround will not be impacted by the lap joint of the second and third skirts

### BRIEF DESCRIPTION OF THE DRAWINGS

FIG. 1 is structure exploded view of a usual speaker unit.

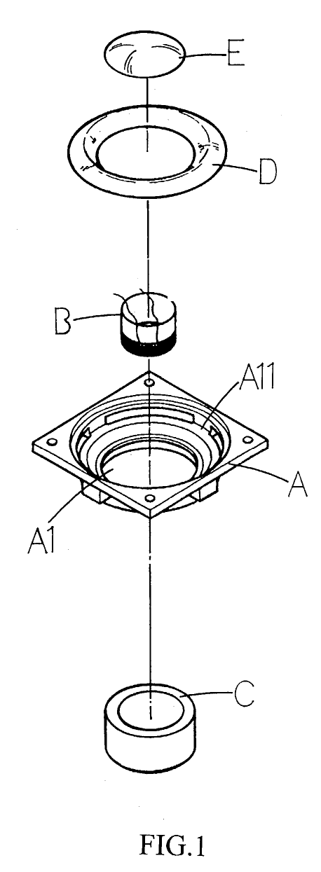

FIG. 2 is structure outside view of the present invention.

FIG. 3 is structure exploded view embodiment of the present invention.

FIG. 4 is cross-sectional view of the present invention.

| (A) | Housing | (A11) | Step Section |
|---|---|---|---|
| (A1) | Circular Slot Hole | (B) | Voice Coil |
| (C) | Yoke | (30) | Yoke |
| (D) | Surround | (40) | Surround |
| (E) | Diaphragm | (41) | The First Skirt |
| (10) | Housing | (42) | The Second Skirt |
| (11) | Circular Slot Hole | (50) | Diaphragm |
| (111) | Step Section | (51) | The Third Skirt |
| (20) | Voice Coil | | |

### DESCRIPTION OF THE PREFERRED EMBODIMENT

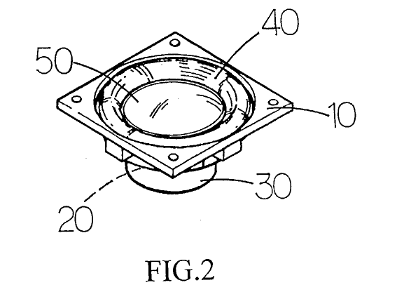

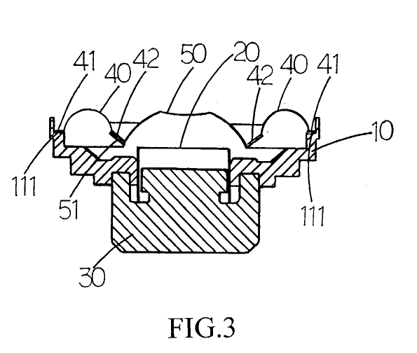

In the invention of Structure Improvement for Speaker Unit, referring to the FIG. 2 and FIG. 3, the basic structure of the speaker includes the main body that is a housing containing a voice coil (20) and a yoke (30) where there is a circular slot hole (11) for containing the voice coil (20) and yoke (30). A surround (40) and a diaphragm (50) are adhered to the top of the circular slot hole (11) that forms the link between the diaphragm (50) and the housing (10) by the effect of the surround (40) to produce sound wave effect as the action and vibration of the voice coil (20) and the yoke (30).

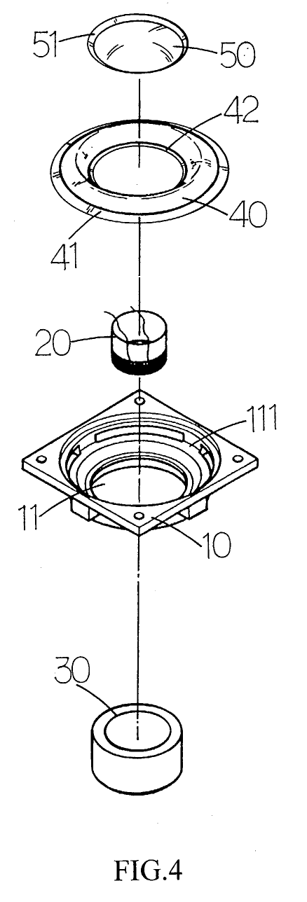

With coordinative reference to FIG. 3 and FIG. 4, there is a step section (111) between the fringe of the circular slot hole (11) of the housing where the voice coil (20) and the yoke (30) are contained and the body of the housing (10). The outer fringe and the inner fringe of the surround (40) respectively form the first skirt (41) and the second skirt (42). The surround (40) is constituted by the lap joint of the first skirt (41) and the step section (111) of the fringe of the circular slot hole (11), and the lap joint of the second skirt (42) of the inner fringe connecting and the diaphragm (50).

Particularly, the outer fringe of the diaphragm (50) forms the third skirt (51), thereof the adherence of the third skirt (51) and the second skirt (42) integrates the diaphragm (50) with the surround (40), and by the setting of the third skirt (51) of the outer fringe of the diaphragm (50), it becomes a specific section for adherence, supporting and fixing that facilitates the adherence of the diaphragm (50) and the surround (40). Otherwise, the second skirt (42) and the third skirt (51) are set with a slantwise spreading-out mode from inner to outer that the lap joint of the second skirt (42) and the third skirt (51) will have no effect on the vibration of the diaphragm (50) and the surround (40), making the speaker unit to behave good diapason.

It is an object of the invention of the Structure Improvement for Speaker Unit to provide a specific section for adherence, supporting and fixing to facilitate the adherence operation of the diaphragm and the surround by the third skirt forming at the outer fringe of the diaphragm, the integration of diaphragm and surround by the lap joint of the third skirt and the second skirt, and the setting of the third skirt. The second skirt at the inner fringe of the surround and the third skirt at the outer fringe of the diaphragm are set with a slantwise spreading-out mode from inner to outer, which will not affect the vibration of the diaphragm and the surround by the lap joint of the second skirt and the third skirt and will provide a feasible and preferable structure for speaker unit. Then the application of the new patent is submitted according to the regulations.

What is claimed is:

1. A kind of Structure Improvement for Speaker Unit, wherein the speaker unit comprising a housing as the main body, a circular slot hole containing voice coil and yoke formed at the body of the housing, a step section formed between the fringe of the circular slot hole and the housing body, a ring surround adhering at the top of the circular slot hole, a first skirt and a second skirt formed respectively by the inner fringe and outer fringe of the surround, the surround that is constituted by the lap joint of the first skirt and the step section of the fringe of the circular slot hole, and the lap joint of the second skirt and a diaphragm; the features comprise:
The lap joint of the third skirt formed at the outer fringe of the diaphragm and the second skirt integrates the diaphragm with the surround, and the setting of the third skirt at the outer fringe of the diaphragm makes it to be a specific adherence, supporting and fixing section, which facilitates the operation of adhering the diaphragm to the surround.

2. The Structure Improvement for Speaker Unit according to claim 1, wherein said second skirt of the inner fringe of the surround and said third skirt of the outer fringe of the diaphragm are set with a slantwise spreading-out mode from inner to outer, which will not affect vibration of the diaphragm and the surround for the lap joint of the second skirt and the third skirt.
